(19) United States
(12) Patent Application Publication
(10) Pub. No.: US 2011/0233910 A1
(43) Pub. Date: Sep. 29, 2011

(54) SKID WHEEL ACCESSORY FOR A RECEIVER HITCH

(76) Inventor: THOMAS J. DIMARCO, JR., Anthem, AZ (US)

(21) Appl. No.: 13/070,035

(22) Filed: Mar. 23, 2011

Related U.S. Application Data
(60) Provisional application No. 61/282,739, filed on Mar. 25, 2010.

(51) Int. Cl. B60B 19/00

(52) U.S. Cl. 280/767

(57) ABSTRACT

The skid wheel accessory for a receiver hitch is removably installed in the receiver hitch receptacle of a vehicle to protect the hitch receptacle and other low and rearward vehicle components from damage when the vehicle negotiates a rising ramp or similar slope change from a level surface. The skid wheel accessory includes a heavy hollow steel tube or solid bar that fits closely within the conventional receiver hitch receptacle of the vehicle. The forward portion of the bar or tube has a lateral passage therethrough, for accepting a hitch pin to secure the accessory in the hitch receptacle. An axle extends across the rearward end of the bar or tube, having at least one (preferably two) solid steel wheel(s) thereon. The wheels contact the underlying surface before other components of the vehicle when negotiating a ramp or slope, thus sparing the hitch receptacle and other vehicle components from damage.

### CROSS-REFERENCE TO RELATED APPLICATION

This application claims the benefit of U.S. Provisional Patent Application Ser. No. 61/282,739, filed Mar. 25, 2010.

### BACKGROUND OF THE INVENTION

1. Field of the Invention

The present invention relates generally to motor vehicle accessories and equipment, and particularly to a skid wheel accessory for a receiver hitch to protect the rear of the vehicle as the vehicle negotiates a change in grade or slope, e.g., from level to an upward slope, or is towed with the front end raised.

2. Description of the Related Art

The typical large motor home and many similar vehicles are now equipped with receiver type tow hitches, i.e., a hitch receiver or receptacle comprising a square section tubular socket. The receptacle is configured to receive a hitch bar having a hitch ball or other towing attachment extending therefrom for towing a correspondingly equipped trailer or the like.

Such motor homes and similar vehicles also generally have relatively long rear overhangs, the majority of the weight of the vehicle being carried by the rear axle or axles. In many cases dual wheels are provided on a single rear axle in order to support the rearward weight. In addition, some vehicles have tandem rear axles. In any event, the long rear overhang and relatively low ground clearance often result in the rear of the vehicle dragging the surface when the front of the vehicle is elevated, as when starting up or backing down an upwardly sloping driveway ramp or the like to or from a level surface or when being loaded aboard the tilted ramp or bed of a flatbed carrier vehicle or hauler, i.e., “rollback.”

Oftentimes the lowest and most rearward point on the subject vehicle is the hitch bar if it has been left in place. Accordingly, the astute operator will generally remove the hitch bar from the receiver when negotiating such irregular surfaces, as when traveling from a level surface to an upward slope. The hitch receptacle is thus generally the first component to contact the surface as the front end of the vehicle is raised, as in negotiating a ramp or being pulled up the tilted bed of a rollback hauler type truck or the like. This will often result in the hitch receptacle being damaged, e.g., flattened so that it is no longer usable, and/or digging into the underlying surface and damaging the surface. If the subject vehicle is being backed down a slope, the receiver hitch receptacle may jam into the surface as the rear of the vehicle reaches level ground, thus stopping all progress until the situation is reversed, and possibly damaging the vehicle.

Thus, a skid wheel accessory for a receiver hitch solving the aforementioned problems is desired.

### SUMMARY OF THE INVENTION

The skid wheel accessory for a receiver hitch is removably installed in the receiver hitch receptacle of a vehicle so equipped, and serves to protect the hitch receptacle and other low and rearward components of the vehicle from damage when the vehicle negotiates a rising ramp or similar change in slope from a level surface. The skid wheel accessory comprises a hollow steel tube having a square cross section, configured to fit closely within a conventional receiver hitch receptacle. Alternatively, the accessory may comprise a solid steel bar, if so desired. The forward portion of the bar or tube includes a lateral passage therethrough for a hitch pin or the like, to lock the accessory in the hitch pin receptacle.

The rearward end of the tube is closed by a heavy plate that serves as an attachment point for a laterally disposed axle shaft welded thereto. The axle preferably has a metal wheel or roller at each end thereof, the wheels extending below the lowermost surface of the bar or tube and rearwardly of the bar or tube. The heavy end closure plate to which the axle is attached serves to transfer and distribute the stresses received by the wheels to the bar or tube of the accessory, and thus to the receiver hitch receptacle and structure of the vehicle without harm to the vehicle. While two wheels are preferably provided, alternatively, a single wheel may be provided. The wheel or wheels may include plain, roller, or ball bearings, as desired.

These and other features of the present invention will become readily apparent upon further review of the following specification and drawings.

### BRIEF DESCRIPTION OF THE DRAWINGS

FIG. 1 is an environmental, perspective view of a vehicle having a skid wheel accessory for a receiver hitch according to the present invention hitch installed in its receiver hitch, showing the protection provided to the hitch system of the vehicle as it is loaded onto the upwardly sloping ramp of another vehicle.

FIG. 2 is an environmental perspective view similar to FIG. 1, but showing the vehicle negotiating a steep upward slope from a level surface.

FIG. 3 is a detailed perspective view of the skid wheel accessory for a receiver hitch according to the present invention, showing various features thereof.

FIG. 4 is a top and rear detailed perspective view of the skid wheel accessory of FIG. 3, showing further details thereof.

FIG. 5 is a top, front perspective view of the skid wheel accessory of FIGS. 3 and 4, showing further details thereof.

FIG. 6 is a side elevation view in section of the skid wheel accessory of FIGS. 3-5, showing further details thereof.

FIG. 7 is an environmental perspective view of a vehicle being loaded onto the sloping ramp of another vehicle according to the prior art, showing scraping of the receiver hitch receptacle of the vehicle as it negotiates the sloping ramp.

Similar reference characters denote corresponding features consistently throughout the attached drawings.

### DETAILED DESCRIPTION OF THE PREFERRED EMBODIMENTS

The skid wheel accessory for a receiver hitch is removably installed to the receptacle of the receiver hitch of a motor vehicle or the like and serves to protect the hitch receptacle and other vehicle structure from damage due to contact with the underlying surface when the forward end of the vehicle becomes elevated, as may occur when negotiating a positive change in grade, or when moving from a level surface and starting up an upwardly sloping ramp or the like.

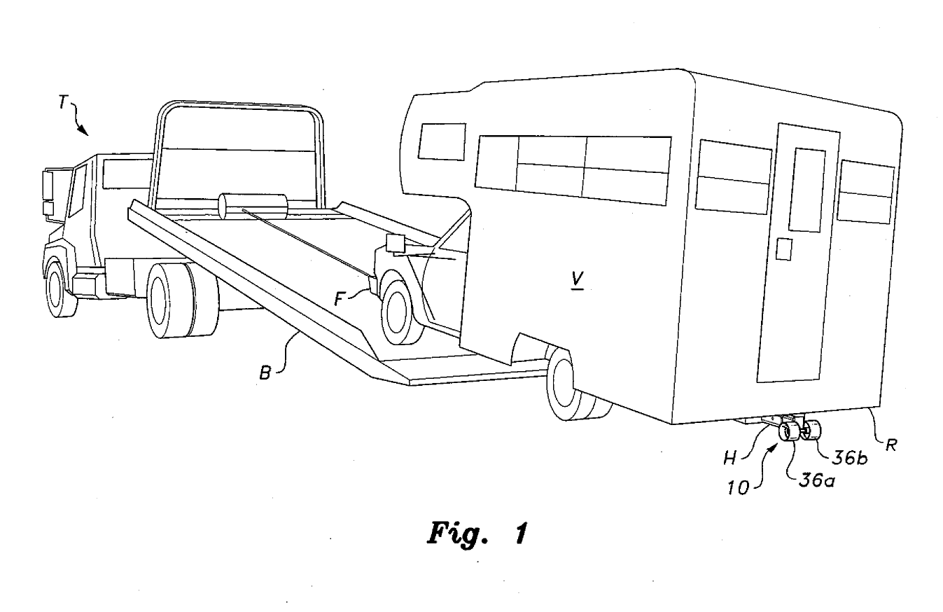

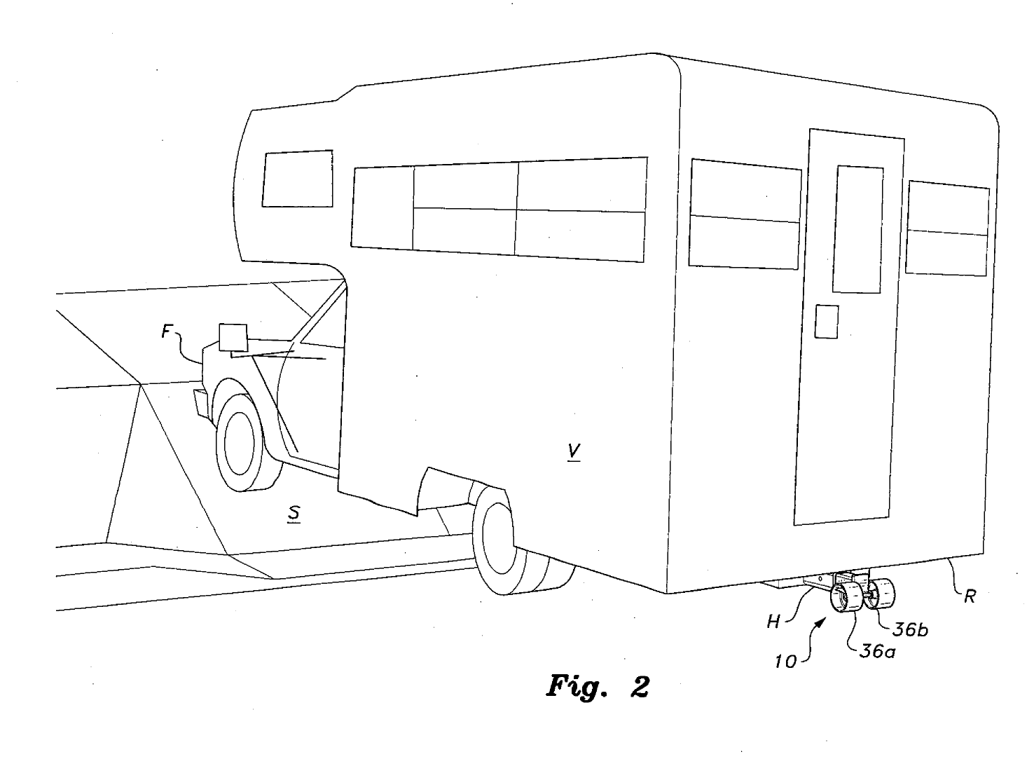

FIGS. 1, 2, and prior art FIG. 7 of the drawings provide environmental perspective views of a large motor home type vehicle V as the vehicle is transitioning over a positive change in grade, e.g., from a level surface onto an upward slope. In FIGS. 1 and 7, the vehicle V is being pulled aboard the tilted ramp or bed B of a rollback type flatbed truck T, while in FIG. 2 the vehicle V is negotiating a ramp with an upward slope S. The upwardly tilted ramp or bed B of the truck T in FIG. 1, or the upward slope S of FIG. 2, forms a positive change in gradient or slope between the truck bed B or slope S and the surface upon which the hauler H and vehicle V are located. As the forward end F of the vehicle V is elevated as it begins its travel up the ramp bed B or slope S, the opposite rearward end R of the vehicle will drop correspondingly.

Large motor home type vehicles V generally have relatively low ground clearance and relatively long rear overhangs beyond the rear axle. This often results in the lower portions of the extreme rear portion R of the vehicle V dragging on the underlying surface, when the vehicle V negotiates a positive change in gradient as shown in FIGS. 1, 2 and prior art FIG. 7. The lowest and most rearward portion of the vehicle V is generally the receptacle of the receiver hitch H, which will drag on the underlying pavement P or other surface as shown in prior art FIG. 7, unless some preventive means is provided.

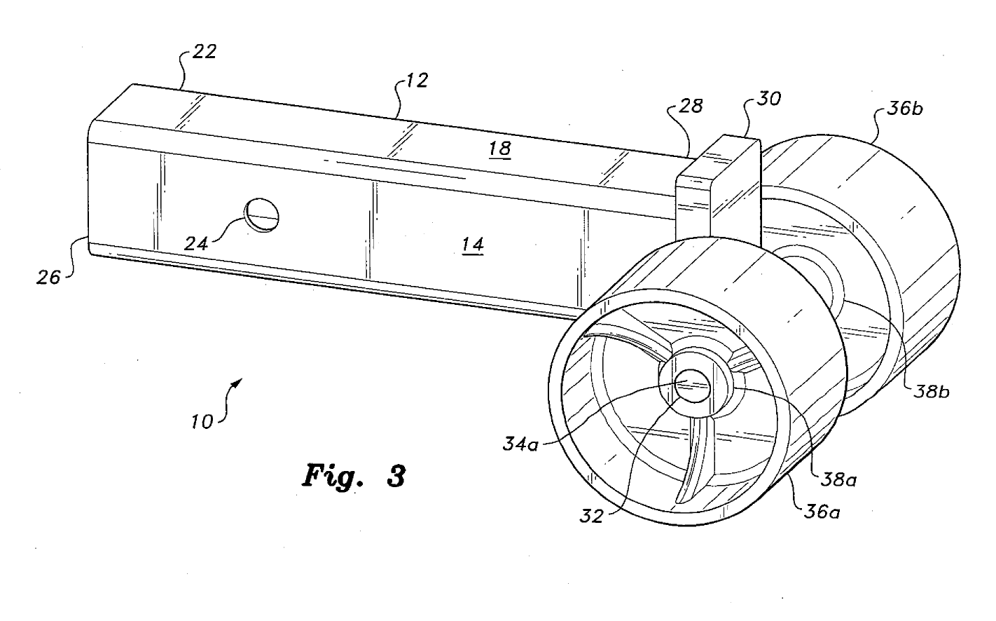

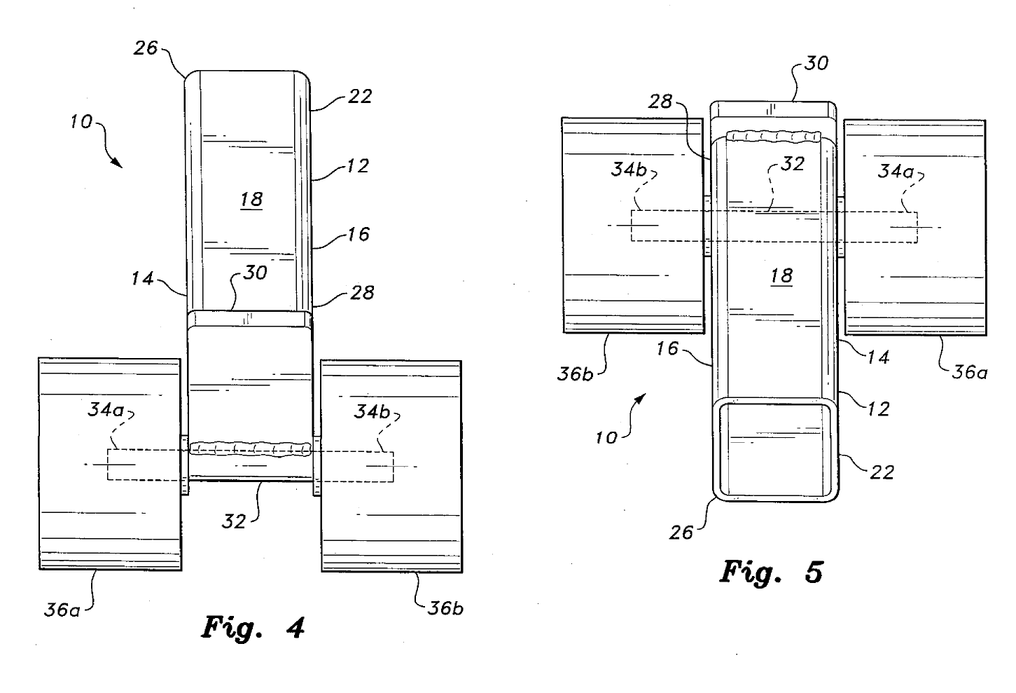

Accordingly, the skid wheel accessory 10 may be removably installed in the receiver hitch receptacle H of the vehicle V, generally as shown in FIGS. 1 and 2 of the drawings, with FIGS. 3 through 6 providing detailed views of the accessory 10. The skid wheel accessory 10 includes an elongate bar 12 having a square or rectangular cross section with mutually opposed left and right side surfaces or walls, respectively 14 and 16, and mutually opposed upper and lower surfaces or walls, respectively 18 and 20. The square or rectangular configuration of the bar 12 is adapted for removable installation in a conventional receiver hitch receptacle H, with the forward portion 22 of the bar 12 including a lateral hitch pin receptacle or passage 24 therethrough or thereacross for securing the bar 12 removably within the hitch receptacle H.

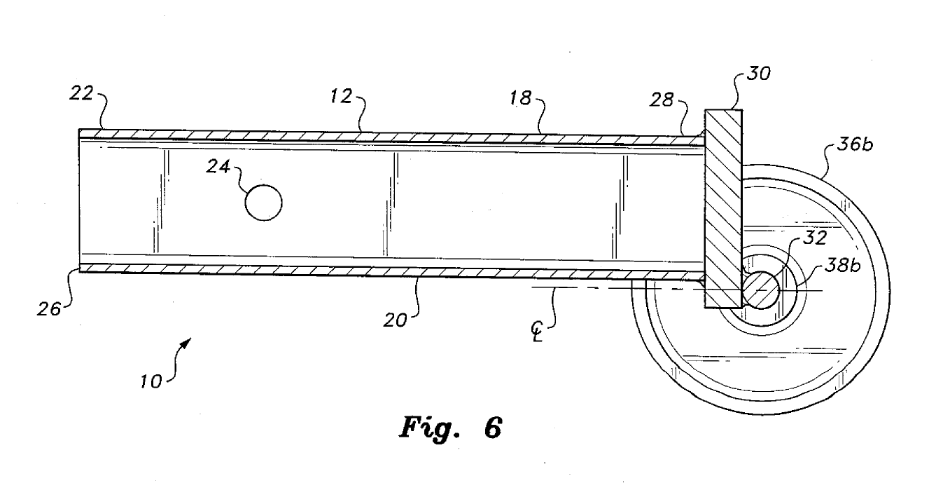

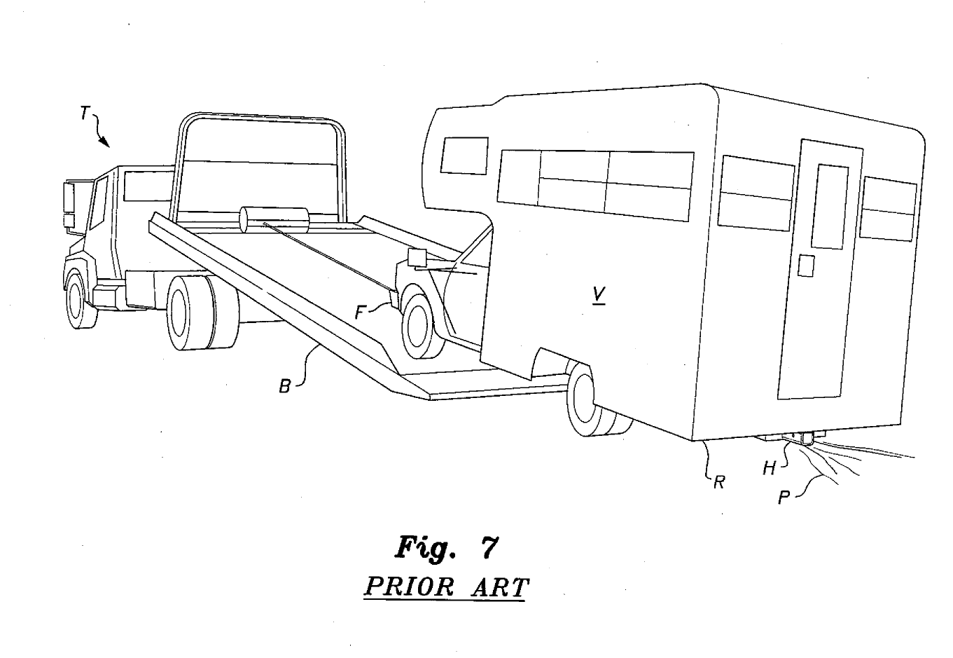

The bar 12 may be formed as a solid steel bar, if so desired, or may alternatively be formed of a length of square section hollow tubing, as shown in FIGS. 5 and 6 of the drawings. When formed of hollow square section tubing, the forward end 26 of the bar may remain open as shown in FIG. 5, but the opposite rearward end 28 is closed by a heavy, thick closure plate 30 affixed (e.g., welded) thereover. The closure plate 30 preferably extends at least downwardly somewhat below the lower surface or wall 20 of the bar 12 generally as shown in FIG. 6, with an axle 32 being affixed (welded, etc.) to the lower rear portion of the closure plate 30. The axle 32 is preferably affixed to the lowermost edge or portion of the plate 30, with the horizontal centerline CL of the axle 32 thus located below the lower wall or surface 20 of the bar 12 and the axle being located at the rearmost point of the skid wheel accessory 10 to position the wheels as low and as rearward as possible.

The axle 32 may be laterally asymmetric, i.e., extending in only one direction laterally from its attachment to the plate 30. However, the axle 32 is preferably substantially laterally symmetrical, with mutually opposed left and right ends, respectively 34a and 34b, extending laterally beyond the two sides 14 and 16 of the bar 12. This provides for the installation of two skid wheels, respectively 36a and 36b, to the two axle end portions 34a and 34b.

The single axle 32 affixed to the closure plate 30 at the rearward end 28 of the bar 12, greatly simplifies the construction of the skid wheel accessory 10 by avoiding the need to cut away a portion of the bar for the installation of a single, centrally located wheel while still providing for symmetrical loading of the bar 12 due to the two laterally opposed wheels. The two wheels 36a, 36b also provide greater total width than would be provided by a single such wheel, thereby reducing the unit pressure imparted to the underlying surface by the two wheels. Also, locating the two wheels 36a, 36b laterally outwardly of the left and right sides 14, 16 of the bar 12 allows the wheels to be made in any practicable width as desired, without being restricted due to any surrounding structure of the bar.

The two wheels 36a, 36b may be of the type conventionally used on many hand trucks or dollies, i.e., of hard metal construction for use on smooth hard surfaces. The wheel bearings 38a, 38b may be of any conventional type, e.g., plain or sleeve bearings, roller bearings, ball bearings, etc. Such bearing types are well known in the field of steel wheels manufactured for hand trucks, dollies, and the like.

The skid wheel accessory 10 may be removably installed in the conventional receiver hitch receptacle H of the subject vehicle V, as described further above. The conventional hitch bar (not shown) is removed and the skid wheel accessory 10 is installed in its place, generally as illustrated in FIGS. 1 and 2. The wheels 36a, 36b are located at the lowest and most rearward point of the vehicle V, and thus make first contact with the underlying surface if such contact between the rear of the vehicle and the underlying surface occurs. The wheels allow the rear R of the vehicle V to roll smoothly over the underlying surface as the vehicle V negotiates the change in gradient, as when being loaded aboard a tilt bed truck T (FIG. 1) or negotiating a sloped ramp S (FIG. 2). This avoids any damage that might be incurred to the receiver hitch receptacle H and/or the underlying pavement P or other surface, as is shown in the prior art illustration of FIG. 7.

It is to be understood that the present invention is not limited to the embodiments described above, but encompasses any and all embodiments within the scope of the following claims.

I claim:

1. A skid wheel accessory for a receiver hitch, comprising:
an elongate metal element adapted for removable insertion in a receiver hitch receptacle, the element having a forward end and a rearward end;
a laterally disposed axle extending across the rearward end of the elongated element, the axle having mutually opposed left and right ends extending beyond opposite sides of the elongated element; and
left and right skid wheels disposed upon the left and right ends of the axle, respectively, the wheels being laterally disposed outward from the elongated element.

2. The skid wheel accessory for a receiver hitch according to claim 1, wherein the elongated element is a hollow metal tube, the skid wheel accessory further comprising a heavy closure plate affixed across a rearward end of the tube, the axle being affixed to the closure plate.

3. The skid wheel accessory for a receiver hitch according to claim 1, wherein each of the wheels is formed of a hard metal.

4. The skid wheel accessory for a receiver hitch according to claim 1, wherein the axle has a center, the center of the axle being disposed below the lower surface of the elongated element.

5. The skid wheel accessory for a receiver hitch according to claim 1, further comprising a heavy closure plate affixed across a rearward end of the elongated element, the closure plate having a rearward surface, the axle being affixed to the rearward surface of the closure plate.

6. The skid wheel accessory for a receiver hitch according to claim 1, wherein each of the wheels has bearings, the bearings being selected from the group consisting of plain bearings, roller bearings, and ball bearings.

7. A skid wheel accessory for a receiver hitch, comprising:
a hollow, elongate metal element adapted for removable insertion in a receiver hitch receptacle, the element having a forward end and a rearward end;
a heavy closure plate affixed across the rearward end of the elongate element;
a laterally disposed axle affixed to the closure plate, the axle having at least one end extending laterally beyond the elongate element; and
at least one skid wheel disposed upon the at least one end of the axle, the wheel being laterally disposed outward from the elongate element.

8. The skid wheel accessory for a receiver hitch according to claim 7, wherein:
said at least one end of the axle extending laterally beyond the elongate element comprises mutually opposed left and right ends extending beyond opposite sides of the elongated element; and
said at least one skid wheel comprises left and right skid wheels disposed upon the left and right ends of the axle, respectively, the wheels being laterally disposed outward from the elongated element.

9. The skid wheel accessory for a receiver hitch according to claim 7, wherein the at least one skid wheel is formed of a hard metal.

10. The skid wheel accessory for a receiver hitch according to claim 7, wherein the axle has a center, the center of the axle being disposed below the lower wall of the elongated element.

11. The skid wheel accessory for a receiver hitch according to claim 7, wherein:
the closure plate has a rearward surface; and
the axle is affixed to the rearward surface of the closure plate.

12. The skid wheel accessory for a receiver hitch according to claim 7, wherein the at least one wheel has bearings, the bearings being selected from the group consisting of plain bearings, roller bearings, and ball bearings.

13. A skid wheel accessory for a receiver hitch, comprising:
an elongate metal element adapted for removable insertion in a receiver hitch receptacle, the element having a forward end and a rearward end;
a laterally disposed axle extending across the elongate element, the axle having at least one end extending laterally beyond the elongate element; and
at least one skid wheel disposed upon the at least one end of the axle, the wheel being laterally disposed outward from the element, the at least one wheel being formed of a hard metal.

14. The skid wheel accessory for a receiver hitch according to claim 13, wherein:
said at least one end of the axle extending laterally beyond the elongate element comprises mutually opposed left and right ends extending beyond opposite sides of the elongated element; and
said at least one skid wheel comprises left and right skid wheels disposed upon the left and right ends of the axle, respectively, the wheels being laterally disposed outward from the elongated element.

15. The skid wheel accessory for a receiver hitch according to claim 13, wherein the elongated element is a hollow metal tube, the skid wheel accessory further comprising a heavy closure plate affixed across the rearward end of the tube, the axle being affixed to the closure plate.

16. The skid wheel accessory for a receiver hitch according to claim 13, wherein the axle has a center, the center of the axle being disposed below the lower surface of the elongated element.

17. The skid wheel accessory for a receiver hitch according to claim 13, further comprising a heavy closure plate affixed across the rearward end of the elongated element, the closure plate having a rearward surface, the axle being affixed to the rearward surface of the closure plate.

18. The skid wheel accessory for a receiver hitch according to claim 13, wherein the at least one wheel has bearings, the bearings being selected from the group consisting of plain bearings, roller bearings, and ball bearings.
